(19) United States
(12) Patent Application Publication
(10) Pub. No.: US 2023/0311614 A1
(43) Pub. Date: Oct. 5, 2023

(54) VEHICLE

(71) Applicant: HONDA MOTOR CO., LTD., Tokyo (JP)

(72) Inventor: Tomohiro NISHIDA, Tokyo (JP)

(73) Assignee: HONDA MOTOR CO., LTD., Tokyo (JP)

(21) Appl. No.: 18/120,671

(22) Filed: Mar. 13, 2023

(30) Foreign Application Priority Data
Mar. 31, 2022 (JP) 2022-060380

(51) Int. Cl. B60H 1/00

(52) U.S. Cl. CPC B60H 1/00535

(57) ABSTRACT

A vehicle includes a vehicle body frame and an air conditioner unit. The air conditioner unit includes an evaporator. The vehicle body frame includes a tubular frame which extends in a tubular shape. The air conditioner unit is mounted to the tubular frame via a stay. Therefore, the air conditioner unit can be easily and stably mounted to the tubular frame.

### CROSS-REFERENCE TO RELATED APPLICATIONS

This application is based on and claims priority under 35 USC 119 from Japanese Patent Application No. 2022-060380 filed on Mar. 31, 2022. The entire content of the priority application is incorporated herein by reference.

### TECHNICAL FIELD

The present disclosure relates to a vehicle including an air conditioner.

### BACKGROUND ART

A vehicle is mounted with a vehicle air conditioner for adjusting an environment in a vehicle cabin to ensure comfort of occupants. For example, a vehicle air conditioner described in JP2002-067655A is fixed to a vehicle body via an intermediate member (casing). The intermediate member is integrally formed with mounting legs extending along an upper-lower direction on an outer wall surface and protruding downward. The mounting legs are mounted on a front deck cross member, and lower parts are mounted to a floor surface of the vehicle.

The vehicle air conditioner described in JP2002-067655A assumes an air conditioner mounted on a passenger car, and has a structure that facilitates mounting of an air conditioner unit to a plate-shaped member such as a dash panel. However, in a vehicle capable of traveling on a rough road, such as a side by side vehicle (SSV), a vehicle body frame may be a tubular frame extending in a tubular shape. In order to mount the air conditioner on such a vehicle, it is necessary to mount the air conditioner unit to the tubular frame extending in a tubular shape, but when the air conditioner unit is mounted to the tubular frame extending in a tubular shape, a problem is present that it is difficult to stably mount the air conditioner unit.

### SUMMARY

The present disclosure provides a vehicle in which an air conditioner unit can be easily and stably mounted to a tubular vehicle body frame.

The present disclosure relates to a vehicle including:
a vehicle body frame; and
an air conditioner unit including an evaporator,
in which the vehicle body frame includes a tubular frame extending in a tubular shape, and
the air conditioner unit is mounted to the tubular frame via a stay.

According to the present disclosure, since the air conditioner unit is mounted to the tubular frame via the stay, the air conditioner unit can be easily and stably mounted to the tubular frame.

### BRIEF DESCRIPTION OF DRAWINGS

Exemplary embodiment(s) of the present disclosure will be described in detail based on the following figures, wherein:

FIG. 1 is a schematic sectional view of main parts of a vehicle according to an embodiment of the present disclosure as viewed from a left side;

FIG. 2 is a perspective view of main parts illustrating a state in which an air conditioner unit is mounted to a tubular frame via a stay;

FIG. 3 is a rear view of the stay mounted to the tubular frame when an air conditioner is removed; and

FIG. 4 is an enlarged perspective view of a portion surrounded by a circle A in FIG. 3.

### DESCRIPTION OF EMBODIMENTS

Hereinafter, an embodiment of a vehicle according to the present disclosure will be described with reference to the accompanying drawings. The drawings are viewed in directions of reference signs. In the present specification and the like, in order to simplify and clarify the description, a front-rear direction, a left-right direction, and an upper-lower direction are described according to directions viewed from a driver of the vehicle. In the drawings, a front side of the vehicle is denoted by Fr, a rear side of the vehicle is denoted by Rr, a left side of the vehicle is denoted by L, a right side of the vehicle is denoted by R, an upper side of the vehicle is denoted by U, and a lower side of the vehicle is denoted by D.

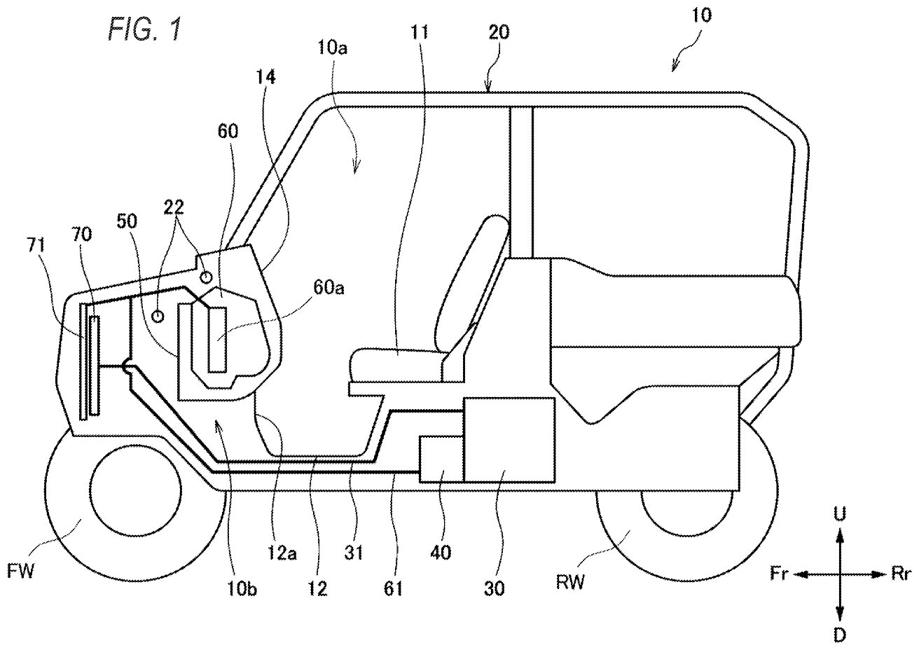

As illustrated in FIG. 1, a vehicle 10 of the present embodiment is a relatively small vehicle for a main purpose of traveling on rough terrain, and includes a front wheel FW, a rear wheel RW, a vehicle body frame 20 formed by combining pipe members, a vehicle cabin 10a surrounded by the vehicle body frame 20 and provided with a seat 11 on which an occupant sits, a floor panel 12 constituting a floor surface of the vehicle cabin 10a, and a front room 10b formed in front of the vehicle cabin 10a. The vehicle cabin 10a and the front room 10b are separated by a front end portion 12a formed by bending a front end portion of the floor panel 12 upward and a dash panel 14 extending in the upper-lower direction and the left-right direction.

The vehicle 10 further includes an engine 30 that is a prime mover and disposed below the seat 11, an air conditioner compressor 40 that is connected to the engine 30 and operates by a rotational power generated by the engine 30, an air conditioner unit 60 that is fixed to the vehicle body frame 20 via a stay 50, and a radiator 70 and a condenser 71 that are disposed in front of the air conditioner unit 60.

The engine 30 and the radiator 70 are connected by an engine cooling water pipe 31 wired below the floor panel 12. The engine cooling water pipe 31 circulates a first refrigerant such as water between the engine 30 and the radiator 70, thereby exchanging heat of the first refrigerant heated by the engine 30 with outside air in the radiator 70 to cool the engine 30.

The air conditioner compressor 40, the air conditioner unit 60, and the condenser 71 are connected by an air conditioner refrigerant pipe 61 wired below the floor panel 12. A second refrigerant compressed and heated by the air conditioner compressor 40 is cooled by heat exchange with the outside air in the condenser 71, is rapidly decompressed by an expansion valve (not illustrated), and is supplied to an evaporator 60a housed in the air conditioner unit 60. In the air conditioner unit 60, air taken into the air conditioner unit 60 from the outside is cooled by the evaporator 60a and blown into the vehicle cabin 10a.

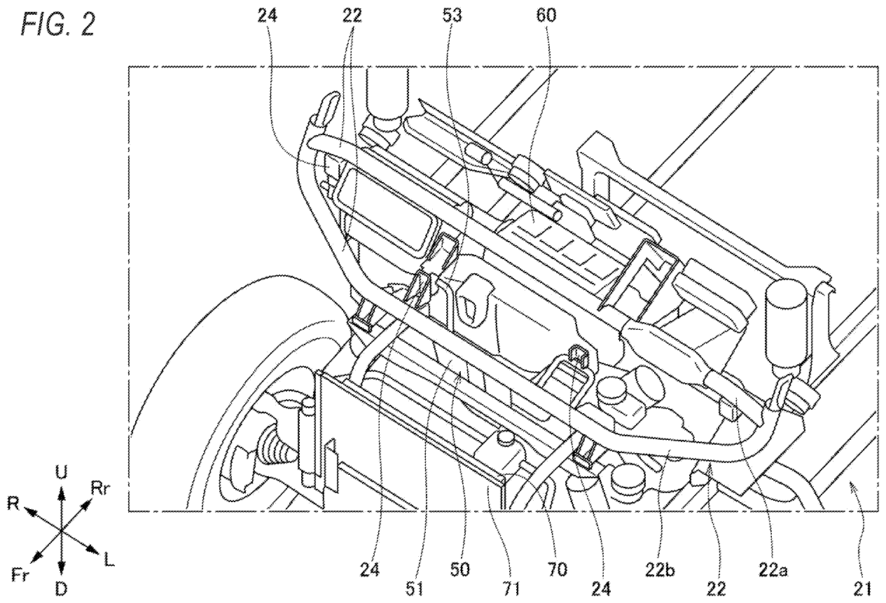

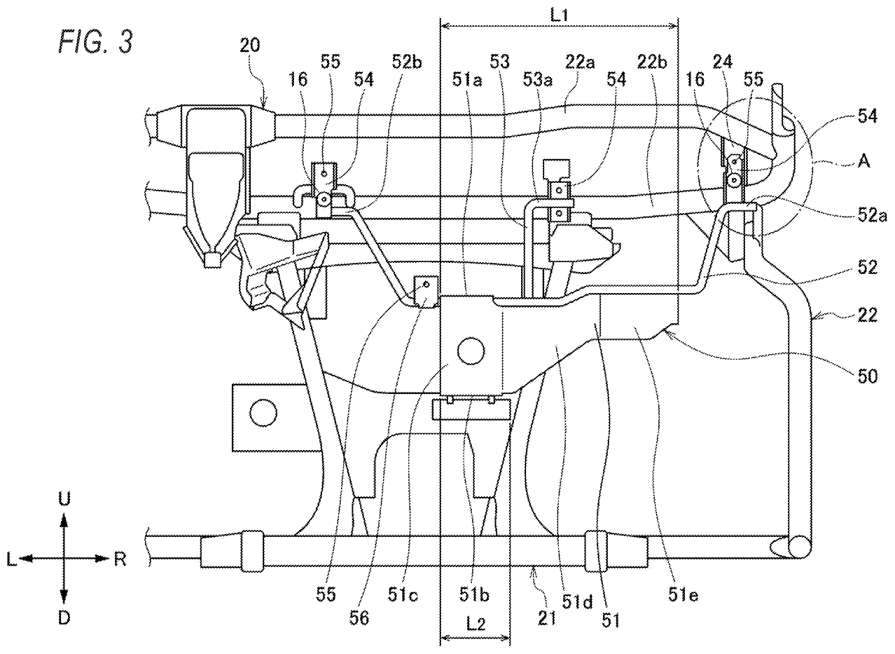

Referring also to FIGS. 2 and 3, the vehicle body frame 20 includes at least a chassis frame 21 including a plurality of pipe members that are disposed in the front-rear direction and the left-right direction and are integrally fixed by welding or the like, and a tubular frame 22 having two pipe members 22a and 22b that rise from both left and right sides of the chassis frame 21 and extend in the left-right direction (first direction) in front of the dash panel 14. A plurality of (three in the drawing) extension portions 24, each of which is formed by bending a flat plate into a substantially U-shaped cross section, extend from the tubular frame 22 (the pipe members 22a and 22b) and are fixed to the tubular frame 22.

The stay 50 includes a board-shaped plate portion 51 and a first tubular portion 52 and a second tubular portion 53 that are fixed to the plate portion 51. The plate portion 51 is formed in a substantially inverted trapezoidal shape in which a vehicle width direction length (first direction length) L1 of an upper end portion 51a is larger than a vehicle width direction length L2 of a lower end portion 51b.

A bent portion or a bead may be appropriately formed in the plate portion 51 in order to improve a strength. In the plate portion 51 illustrated in FIG. 3, a left side portion 51c is bent toward a front side of the drawing (toward a vehicle rear side) by a thickness of the first tubular portion 52 with respect to a central portion 51d, and is formed in a substantially crank shape in cross section. A right side portion 51e is bent toward a back side of the drawing (toward a vehicle front side) with respect to the central portion 51d, and is formed in a substantially crank shape in cross section. Therefore, in the present embodiment, the plate portion 51 is bent in an order of the left side portion 51c, the central portion 51d, and the right side portion 51e to form a stepped shape toward the front side of the vehicle, and extends in the left-right direction in a substantially crank shape in cross section. The plate portion 51 may not extend into the stepped shape in the left-right direction, may have a flat plate, or may be bent and/or curved in any direction.

The first tubular portion 52 extending in the left-right direction along the upper end portion 51a of the plate portion 51 is fixed by welding or the like to the upper end portion 51a. Specifically, the first tubular portion 52 is connected to a surface of the left side portion 51c of the plate portion 51 on the vehicle front side and extends in the left-right direction, is connected to an upper end of the central portion 51d of the plate portion 51 and extends in the left-right direction, is connected to a surface of the right side portion 51e of the plate portion 51 on the vehicle rear side and extends in the left-right direction, and is fixed by welding to the upper end portion 51a of the plate portion 51.

The lower end portion 51b of the plate portion 51 is bent toward the back side of the drawing (toward the vehicle front side) and is formed in a substantially crank shape in cross section. The vehicle body frame 20 extends in the left-right direction along the lower end portion 51b of the plate portion 51, and is provided with the stay 50 extending in a substantially L shape when viewed from the left-right direction. The lower end portion 51b of the plate portion 51 is fastened, by a fastening member such as a bolt, in the upper-lower direction to the stay 50 provided on the vehicle body frame 20 and extending in the substantially L shape. As a result, the air conditioner unit 60 can be mounted in a limited space in the upper-lower direction, and thus an assembling property is improved and the air conditioner unit 60 can be stably supported from the lower side.

The plate portion 51 may be provided with a lightening hole. As a result, a weight of the stay 50 can be reduced. In the present embodiment, the lightening hole is provided in the left side portion 51c of the plate portion 51.

A vehicle width direction length of the first tubular portion 52 is larger than the vehicle width direction length L1 of the upper end portion 51a of the plate portion 51, and the first tubular portion 52 extends to protrude to the left and right from the plate portion 51. Protruding portions of the first tubular portion 52 protruding from the plate portion 51 are extended obliquely upward toward an outer side in the vehicle width direction, and a right end portion 52a and a left end portion 52b of the first tubular portion 52 are bent toward the outer side in the vehicle width direction and in a horizontal direction. Further, the second tubular portion 53 is fixed by welding to a substantially central portion of the first tubular portion 52, extends upward, and has a distal end portion 53a that is bent rightward.

As described above, since the stay 50 includes the first tubular portion 52 and the second tubular portion 53 extending in a tubular shape, it is possible to reduce a weight and a cost while ensuring rigidity of the stay 50, and to easily mold the stay 50.

A stay mounting portion 54 formed in a substantially U-shaped cross section is fixed by welding to each of the right end portion 52a and the left end portion 52b of the first tubular portion 52 and the distal end portion 53a of the second tubular portion 53. An outer width of the stay mounting portion 54 having a substantially U-shaped cross section is smaller than an inner width of the extension portion 24 having a substantially U-shaped cross section and provided on the tubular frame 22, and the stay mounting portion 54 is fitted inside the extension portion 24 provided in the tubular frame 22. Each stay mounting portion 54 is provided with a bolt hole 55 for fastening and fixing the air conditioner unit 60 and a hole 16 for mounting an elastic member 15 which will be described later.

As illustrated in FIG. 3, an air conditioner unit mounting portion 56, which is adjacent to the plate portion 51 and is provided with the bolt hole 55, is fixed by welding to the first tubular portion 52, which extends leftward from the plate portion 51.

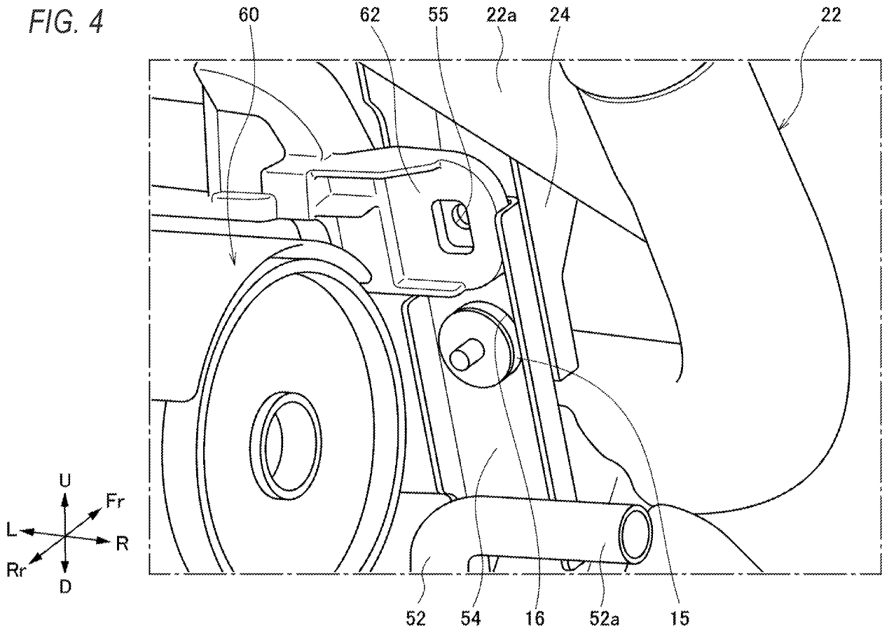

As illustrated in FIG. 4, each of the stay mounting portions 54 provided at the first tubular portion 52 and the distal end portion of the second tubular portion 53 is fastened to the extension portion 24 of the tubular frame 22 by a fastening bolt (not illustrated) via the elastic member 15 such as rubber attached to the hole 16. The air conditioner unit 60 is fixed to the stay 50 by fastening mounting ribs 62 provided in the air conditioner unit 60 by fastening bolts (not illustrated) inserted through the three stay mounting portions 54 and the bolt hole 55 of the air conditioner unit mounting portion 56.

As described above, since the air conditioner unit 60 is mounted to the tubular frame 22 via the stay 50, the air conditioner unit 60 can be easily and stably mounted to the tubular frame 22 when a cross section of the tubular frame 22 has a circular shape.

Further, since the stay 50 is fixed to the extension portions 24 extending from the tubular frame 22, the stay 50 can be fixed to the tubular frame 22 at a position separated from the tubular frame 22. Accordingly, it is possible to prevent vibration of the tubular frame 22 from being transmitted to the air conditioner unit 60 via the stay 50. Further, it is possible to dispose the air conditioner unit 60, which is an uneven object, substantially parallel to the tubular frame 22 (pipe member 22b) while preventing the vibration of the air conditioner unit 60.

When the tubular frame 22 vibrates due to unevenness or the like of a road surface during traveling of the vehicle, the vibration of the tubular frame 22 is absorbed by the elastic member 15. Accordingly, since the vibration of the tubular frame 22 is prevented from being transmitted to the stay 50, it is possible to prevent the vibration of the tubular frame 22 from being transmitted to the air conditioner unit 60 via the stay 50.

As described above, the vehicle width direction length (first direction length) L1 of the upper end portion 51a of the plate portion 51 is larger than the vehicle width direction length L2 of the lower end portion 51b of the plate portion 51, and thus the air conditioner unit 60 can be supported on a larger surface in the upper end portion 51a of the plate portion 51. Therefore, the air conditioner unit 60 is more stably supported by the stay 50. Since a load received from the air conditioner unit 60 can be more dispersed and received by the upper end portion 51a of the plate portion 51, a stress applied to the stay 50 can be dispersed.

The stay 50 is disposed behind the radiator 70 and the condenser 71, and is disposed at a position overlapping the radiator 70 and the condenser 71 when viewed from the front side of the vehicle 10. Therefore, since a flow of air that passes through the radiator 70 and the condenser 71 during traveling and is heated by exhaust heat from the radiator 70 and the condenser 71 is blocked by the stay 50, it is possible to prevent the exhaust heat from the radiator 70 and the condenser 71 from influencing a device disposed behind the stay 50 including the air conditioner unit 60.

Although various embodiments are described above with reference to the drawings, it is needless to say that the present invention is not limited to such examples. It is apparent to a person skilled in the art that various changes and modifications can be conceived within the scope of the claims, and it is also understood that such changes and modifications naturally belong to the technical scope of the present invention. In addition, constituent elements in the above embodiments may be combined freely within a range not departing from the spirit of the invention.

At least the following matters are described in the present specification. Although corresponding components or the like in the embodiment described above are shown in parentheses, the present invention is not limited thereto.

(1) A vehicle (vehicle 10), including:
a vehicle body frame (vehicle body frame 20); and
an air conditioner unit (air conditioner unit 60) including an evaporator (evaporator 60a),
in which the vehicle body frame includes a tubular frame (tubular frame 22) extending in a tubular shape, and
the air conditioner unit is mounted to the tubular frame via a stay (stay 50).

According to (1), since the air conditioner unit is mounted to the tubular frame via the stay, the air conditioner unit can be easily and stably mounted to the tubular frame.

(2) The vehicle according to (1),
in which the stay includes a tubular portion (first tubular portion 52 and second tubular portion 53) extending in a tubular shape.

According to (2), since the stay includes the tubular portion that extends in a tubular shape, it is possible to reduce a weight and a cost while ensuring rigidity of the stay, and to easily mold the stay.

(3) The vehicle according to (1) or (2),
in which the tubular frame extends in a first direction,
the stay includes a plate portion (plate portion 51) having a board shape and extending in an upper-lower direction and the first direction, and
a length (vehicle width direction length L1) of an upper end portion (upper end portion 51a) of the plate portion in the first direction is larger than a length (vehicle width direction length L2) of a lower end portion (lower end portion 51b) of the plate portion in the first direction.

According to (3), since the length of the upper end portion of the plate portion in the first direction is larger than the length of the lower end portion of the plate portion in the first direction, the air conditioner unit can be supported on a larger surface in the upper end portion of the plate portion. Therefore, the air conditioner unit is more stably supported by the stay. Since a load received from the air conditioner unit can be more dispersed and received by the upper end portion of the plate portion, a stress applied to the stay can be dispersed.

(4) The vehicle according to any one of (1) to (3),
in which the stay is fixed to the tubular frame via an elastic member (elastic member 15) interposed between the stay and the tubular frame.

According to (4), since the stay is fixed to the tubular frame via the elastic member interposed between the stay and the tubular frame, the vibration of the tubular frame is absorbed by the elastic member even in a case where the tubular frame vibrates due to the unevenness or the like of the road surface during traveling of the vehicle. Accordingly, since the vibration of the tubular frame is prevented from being transmitted to the stay, it is possible to prevent the vibration of the tubular frame from being transmitted to the air conditioner unit via the stay.

(5) The vehicle according to any one of (1) to (4), further including:
a prime mover (engine 30);
a radiator (radiator 70) configured to exchange heat between outside air and a first refrigerant that cools the prime mover; and
a condenser (condenser 71) configured to exchange heat between the outside air and a second refrigerant that flows through the evaporator,
in which at least a portion of the stay is disposed behind the radiator and the condenser, and is disposed at a position overlapping the radiator and the condenser when viewed from a front side of the vehicle.

According to (5), since the stay is disposed behind the radiator and the condenser and is disposed at a position overlapping the radiator and the condenser when viewed from the front side of the vehicle, it is possible to prevent an air that passes through the radiator and the condenser and heated from flowing to the rear side of the stay during the traveling of the vehicle. Accordingly, it is possible to reduce the influence of the exhaust heat from the radiator and the condenser on the device disposed behind the stay including the air conditioner unit.

(6) The vehicle according to any one of (1) to (5),
in which the tubular frame is provided with at least one extension portion (extension portion 24) extending from the tubular frame, and
the stay is fixed to the extension portion.

According to (6), since the stay is fixed to the extension portion extending from the tubular frame, the stay can be fixed to the tubular frame at a position separated from the tubular frame. Accordingly, it is possible to prevent the vibration of the tubular frame from being transmitted to the air conditioner unit via the stay.

What is claimed is:

1. A vehicle comprising:
a vehicle body frame; and
an air conditioner unit including an evaporator,
wherein the vehicle body frame includes a tubular frame extending in a tubular shape, and
the air conditioner unit is mounted to the tubular frame via a stay.

2. The vehicle according to claim 1,
wherein the stay includes a tubular portion extending in a tubular shape.

3. The vehicle according to claim 1,
wherein the tubular frame extends in a first direction,
the stay includes a plate portion having a board shape and extending in an upper-lower direction and the first direction, and
a length of an upper end portion of the plate portion in the first direction is larger than a length of a lower end portion of the plate portion in the first direction.

4. The vehicle according to claim 1,
wherein the stay is fixed to the tubular frame via an elastic member interposed between the stay and the tubular frame.

5. The vehicle according to claim 1, further comprising:
a prime mover;
a radiator configured to exchange heat between outside air and a first refrigerant that cools the prime mover; and
a condenser configured to exchange heat between the outside air and a second refrigerant that flows through the evaporator,
wherein at least a portion of the stay is disposed behind the radiator and the condenser, and is disposed at a position overlapping the radiator and the condenser when viewed from a front side of the vehicle.

6. The vehicle according to claim 1,
wherein the tubular frame is provided with at least one extension portion extending from the tubular frame, and
the stay is fixed to the extension portion.
